(19) United States
(12) Patent Application Publication
(10) Pub. No.: US 2026/0241820 A1
(43) Pub. Date: Aug. 20, 2026

(54) AUTONOMOUS MANIPULATION OF A CHARGING CONNECTOR FOR ELECTRIC VEHICLE CHARGING

(71) Applicant: Rocsys B.V., Rijswijk (NL)

(72) Inventors: Remy van Rooijen, Rijswijk (NL); Hannes Krueger, Rijswijk (NL); Sven Noah van der Lee, Rijswijk (NL); Johannes Oosten van der Weijde, Delft (NL)

(21) Appl. No.: 19/544,608

(22) Filed: Feb. 19, 2026

(30) Foreign Application Priority Data
Feb. 19, 2025 (NL) 2039809

(51) Int. Cl. B60L 53/37; B25J 9/16; B25J 15/00; B60L 53/16

(52) U.S. Cl. CPC B60L 53/37; B25J 9/1687; B25J 9/1697; B25J 15/0019; B60L 53/16

(57) ABSTRACT

The present invention relates to a system, and related devices and methods for autonomously manipulating a charging connector assembly for charging an electric vehicle (EV). The system comprises a robotic manipulator with a coupling assembly configured to releasably couple to the connector assembly, a detection device configured to generate position information, and a control unit configured to control coupling/uncoupling of the connector assembly to the robotic manipulator and mating/unmating of the connector assembly to and from an EV charging inlet based on the position information.

### CROSS-REFERENCE TO RELATED APPLICATION

The present application claims priority from pending Netherlands Patent Application No. 2039809, filed Feb. 19, 2025, which is incorporated herein by reference.

### TECHNICAL FIELD

The present invention relates to electric vehicle (EV) charging systems, and more particularly to a method for autonomous manipulation of a charging connector assembly for mating and unmating the connector assembly to and from an electric vehicle charging inlet. The invention lies in the field of robotic charging infrastructure, and automated fleet charging systems.

### BACKGROUND

The adoption of electric vehicles (EVs) has significantly increased in recent years, requiring efficient and reliable charging solutions. Conventional charging processes require manual intervention, where a user must physically connect and disconnect a charging connector to and from the vehicle’s inlet.

To address these issues, automated and robotic charging systems have been developed. These typically feature actuated robotic systems, mechanisms to support and manipulate a charging connector, and computer vision technologies or other sensing means to detect the presence of objects around the system.

However, existing robotic charging solutions often lack reliability when handling charging connectors in a releasable manner, i.e., connecting the charging connector to the EV inlet and subsequently releasing it, allowing the charging process to continue while the robotic system remains available to serve other parking bays or vehicles. Both the connection and release process, as well as the retrieval of the charging connector when in standby, may introduce challenges related to: alignment precision, secure coupling, and detachment, amongst others.

These challenges can lead to operational inefficiencies, mechanical wear, or failed charging attempts, particularly in multi-vehicle charging environments or high-use scenarios.

The present disclosure addresses the challenges described herein.

### SUMMARY

A first embodiment of the present disclosure relates to a method for manipulating a charging connector assembly for autonomous charging of an electric vehicle, comprising: obtaining position information of the connector assembly; determining, based on the position information, a coupling strategy; mating and unmating the connector assembly to and from the EV inlet by coupling the robotic manipulator to the connector assembly via the coupling assembly based on the coupling strategy; and uncoupling the robotic manipulator from the connector assembly after the connector assembly is either connected to the EV inlet or docked on a docking unit when disconnected from the EV inlet.

The invention provides an automated solution for handling a charging connector assembly, facilitating alignment, coupling, and controlled mating and unmating and disconnection from an EV inlet, while allowing the connector assembly to be released from the robotic manipulator during vehicle charging. The system enables autonomous retrieval, positioning, and engagement of the connector assembly, thereby reducing or eliminating the need for manual intervention and allowing operation across multiple vehicles and charging cycles. By utilizing position information in combination with a defined coupling strategy, the system can adapt to variations in connector positioning, EV inlet location, and environmental conditions.

A second embodiment of the present disclosure relates to a system for autonomous manipulation of a charging connector assembly for electric vehicle charging, comprising: a robotic manipulator; a coupling assembly attached to a distal end of the robotic manipulator and configured to releasably couple the robotic manipulator to the connector assembly; a detection device configured to generate position information of the connector assembly and/or the EV inlet; and a control unit configured to utilize the position information to determine a coupling strategy and to control the robotic manipulator for mating and unmating the connector assembly to and from the EV inlet, and for uncoupling the robotic manipulator from the connector assembly after mating or after docking of the connector assembly on a docking unit.

### BRIEF DESCRIPTION OF THE DRAWINGS

FIG. 1A is a simplified structural block diagram of a system 100 according to the first embodiment of the disclosure. FIG. 1A also depicts a charging station management system 200, a connector assembly 400 and a vehicle 300.

FIG. 1B is simplified structural block diagram of a control unit 140.

FIG. 2A is a schematic diagram of a parking bay and a system in accordance with the present disclosure.

FIG. 2B is a perspective view of an exemplary coupling assembly.

FIGS. 3A and 3B are perspective views of an exemplary coupling assembly.

FIG. 4 is a perspective view of an exemplary coupling assembly.

FIGS. 5A and 5B are perspective views of an exemplary coupling assembly.

FIG. 6 is a flowchart of a method according to the first embodiment of the disclosure.

FIG. 7 shows a simplified structural block diagram of a computing environment.

### BRIEF DESCRIPTION OF THE PRIOR ART

US 2021 008991 A1 describes an arrangement for connecting a charging plug to a charging interface of a vehicle. A moving apparatus with multiple controllable movement axes is described, enabling positioning of a tool that holds the charging plug. The tool is equipped with a centering device, which allows the charging plug to be aligned within the tool before connection. The tool features a controllable tool movement axis, which allows independent movement of the charging plug relative to the movement axes of the moving apparatus.

### DETAILED DESCRIPTION OF THE INVENTION

The present invention is described with reference to flowcharts and block diagrams illustrating embodiments of the method, system, and apparatus, wherein each block or combination of blocks may be implemented by computer program instructions and/or corresponding hardware. The instructions may be executed by a general-purpose or special-purpose computer, embedded processor, or other programmable device to perform the specified functions or operations, and may be stored in a computer-readable memory to configure the device accordingly. The instructions may further be loaded onto a computer or programmable device to execute a sequence of steps resulting in computer-implemented processing, wherein the order of operations shown in the flowcharts may vary and certain blocks may be performed simultaneously or in reverse order depending on the specific implementation.

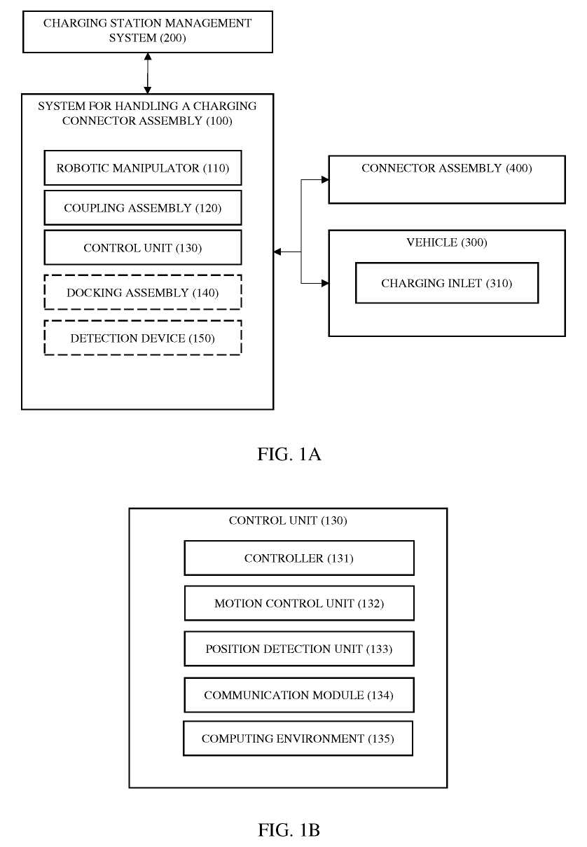

A system 100 for handling a charging connector assembly according to an implementation of the present disclosure will be described below in conjunction with FIG. 1A.

FIG. 1A, is a schematic block diagram of the system 100, which includes a robotic manipulator 110; a coupling assembly 120 coupled to the robotic manipulator 110; and a control unit 130. The system 100 may optionally comprise a docking unit 140 to support the connector assembly 400 and a detection device 150 to provide position information of one or more various components of the system or its surroundings. As used herein, connector assembly may refer to either the charging connector alone or the charging connector along with additional structural or functional components attached to it, which facilitate engagement, alignment, locking, and electrical connection with the EV inlet and the coupling assembly 120.

The system 100 is configured to autonomously manipulate the connector assembly 400 by performing coupling, uncoupling, mating, and unmating operations under the control of the control unit 130. As used herein coupling and uncoupling refers to establishing and releasing a mechanical connection between the coupling assembly of the robotic manipulator and the connector assembly. Mating and unmating refer to establishing and releasing a mechanical and electrical engagement between the connector assembly and the EV inlet, such that the connector assembly is inserted into and removed from the EV inlet to enable and terminate electrical charging, respectively. Docking and undocking, as used herein, refer to positioning and securing the connector assembly in, and removing the connector assembly from, a docking unit when the connector assembly is not mated to the EV inlet, thereby defining a stored or standby position of the connector assembly.

Position information of the connector assembly may be generated through various means, including by the robotic manipulator itself and/or by the detection device. In one embodiment, the robotic manipulator generates position information based on kinematic data, sensors, joint encoder values, and known geometric relationships between the coupling assembly and the connector assembly when coupled. Suitable sensors include joint encoders, torque sensors, force sensors, position sensors, inertial measurement units (IMUs), and proximity sensors integrated into the robotic manipulator or the coupling assembly.

Furthermore, the detection device, such as an image-generating device, generates position information based on image data representative of the connector assembly, the EV inlet, and/or the docking unit. The control unit processes the generated position information to determine a spatial position and/or orientation of the connector assembly within a defined coordinate system for controlling coupling, mating, unmating, docking, and undocking operations.

Position information of the docking unit may be predetermined and stored in the control unit as a docking unit predetermined position within a defined coordinate system of the system 100. The docking unit predetermined position may be defined during installation and calibration of the system and may represent a nominal spatial position and orientation of the docking unit relative to the robotic manipulator. During docking and undocking operations, the control unit may use the docking unit predetermined position as a reference position for coarse positioning of the robotic manipulator and may, when required, refine said position information using additional position information generated by the detection device.

At any step of the process, position information of the connector assembly, the coupling assembly, the EV inlet, and/or the docking unit may be generated by either the robotic manipulator or the detection device, or by a combination thereof, depending on the operational state and the availability or reliability of the respective sensing sources.

With further reference to the components depicted in FIG. 1A, the robotic manipulator 110 is configured to position the coupling assembly 120 relative to the connector assembly 400 based on generated position information. To initiate a charging operation, the system couples the robotic manipulator 110 to the connector assembly 400 via the coupling assembly 120, and subsequently mates the connector assembly 400 to the charging inlet. This configuration is particularly advantageous when the connector assembly 400 is supported by a docking unit 140 while in a standby state. Once the connector assembly 400 is mated to the charging inlet, the robotic manipulator 110 may uncouple from the connector assembly 400, thereby allowing the charging process to proceed while the robotic manipulator 110 remains available for other operations. Upon receiving an unmating command, for example after completion of the charging process, the system re-couples the robotic manipulator 110 to the connector assembly 400. After unmating the connector assembly 400 from the charging inlet, the robotic manipulator 110 positions the connector assembly 400 onto the docking unit 140 and subsequently uncouples from the connector assembly 400, leaving the connector assembly 400 in a defined standby position until required for a subsequent charging cycle.

The system 100 may, but does not necessarily have to, be managed by a charging station management system 200, which is configured to oversee operation of the system 100 and, optionally, other connected systems, such as a fleet management system or a vehicle backend. Such centralized management is particularly advantageous in installations comprising multiple robotic manipulators, as the charging station management system 200 may coordinate task allocation, charging schedules, and resource utilization among the robotic manipulators. In such configurations, mating, unmating, docking, or undocking tasks may be distributed between different robotic manipulators, and position information generated during execution of a task by one robotic manipulator may be shared with another robotic manipulator to enable efficient continuation of the charging process.

The robotic manipulator 110 may be any suitable motion assembly configured to perform the actions described herein. The motion assembly may include at least two actuators, preferably at least three actuators, and more preferably at least six actuators, together configured to provide control over position and/or orientation, and movement. Such actuators facilitate the robotic manipulator to perform various motions, including translational, rotational, tilting, and lifting movements, as required for interaction with the charging connector assembly 400 during connection, disconnection, retrieval, and repositioning operations.

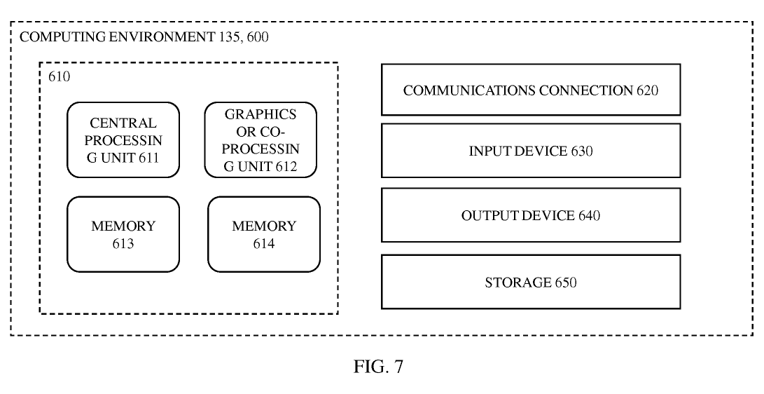

The control unit 130, with reference to FIG. 1A, comprises a controller 131 configured to manage operations of the system 100 and associated components; a motion control unit 132 configured to control movement and actions of the robotic manipulator 110; a position detection unit 133 configured to process visual and/or sensor data received from the detection device 150; and a communication module 134 configured to facilitate data exchange between the management system 200, the system 100, the vehicle 300, and/or the control unit 130 using any suitable communication means. The system 100 further comprises, or is operatively connected to, a computing environment 135, which provides computational resources for execution of control algorithms and data processing, as further detailed in FIG. 7.

In further reference to FIG. 1A, the system 100 comprises, or is in communication with a detection device 150. The detection device 150 is configured to provide or generate position information of the connector assembly 400 at certain moments during the charging cycle. Additionally, the detection device may be configured to provide or generate position information of the EV charging inlet 310 and/or the docking unit 140, which holds the charging assembly when not in use.

The detection device 150 comprises an imaging sensor, such as a camera. The camera may be mechanically coupled to robotic manipulator 110 and can thus be coupled to the movement of the manipulator and any of its components. In some embodiments the camera is coupled to a base component of the robotic manipulator or to the frame system, and thus its position can remain substantially unchanged in relation to the movement of the manipulator 110. This may be advantageous as a fixed camera position can provide a stable reference for detecting the position of the charging connector assembly 400, the EV inlet 310, and other surrounding components without being affected by the manipulator movements. Additionally, a manipulator-mounted camera allows for real-time position tracking as the robotic manipulator moves, which may be advantageous during coupling and uncoupling.

With further reference to FIG. 1A, the system 100 comprises a docking unit 140 configured for docking and undocking the connector assembly when it is not mated to the EV inlet or otherwise not in use. The docking unit 140 is arranged to receive and retain the charging connector assembly in a predetermined docking position. Such predetermined docking position is a known position to the system 100 and/or the control unit 130, and may be pre-stored, thereby enabling the control unit 130 to determine the position of the connector assembly when it is docked in the docking unit 140. Optionally, the position of the connector assembly may be determined using a combination of data sources, including the predetermined docking position for an initial position estimation and real-time data obtained from the detection device for precise or refined position verification.

The docking unit 140 may include structural guides, docking elements, or securing mechanisms configured to facilitate repeatable docking and undocking of the connector assembly while preventing unintended movement or misalignment. In an exemplary embodiment, the docking unit 140 comprises a receptacle having a configuration substantially similar to that of an EV inlet, thereby simulating alignment and positioning cocontrol unitnditions of the mating process.

The predetermined docking position may be defined as a reference position in which the connector assembly is aligned with the docking unit 140 in a manner that allows repeatable and accurate retrieval by the robotic manipulator 110. This position may be determined based on spatial coordinates, mechanical engagement features, or sensor-based detection methods.

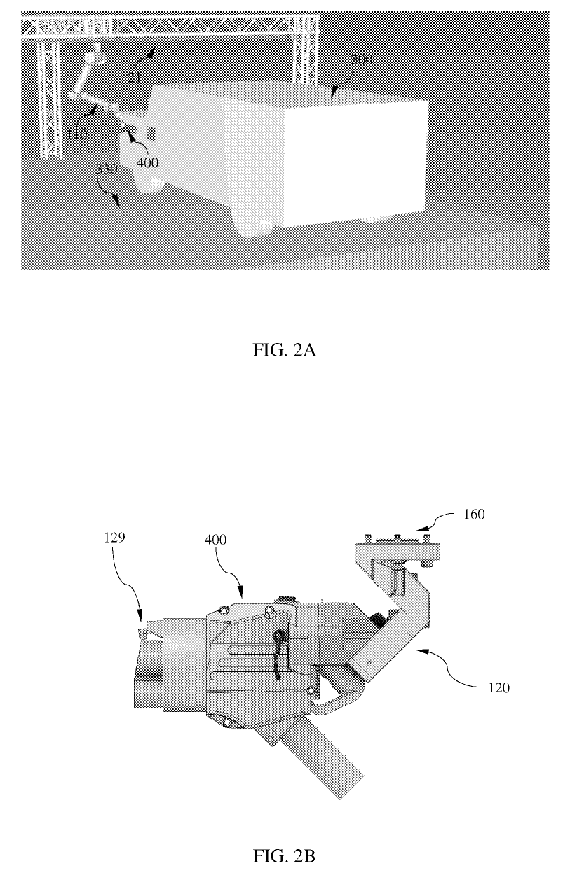

The docking unit 140 may further comprise a locking mechanism configured to retain the connector assembly in the predetermined docking position until it is retrieved by the robotic manipulator 110. The locking mechanism may be actuated mechanically, electrically, or magnetically, and may be controlled by the control unit 130 to engage or release the connector assembly in accordance with operational requirements. Such locking mechanism may interact with the charging connector latching mechanism 139, as depicted in FIG. 2B.

The docking unit 140 may additionally incorporate dust or debris prevention features, such as sealing covers, drainage channels, or passive shielding elements.

FIG. 2A depicts a parking bay 330 and a vehicle 300 positioned in the vicinity of a robotic manipulator 110 which is coupled to the connector assembly 400. The robotic manipulator 110 is mounted on a frame system, such as a rail 21 which facilitates its movement across multiple parking bays (other bays not shown). However, the robotic manipulator 110 may be mounted on any suitable support structure that facilitates its placement in a position suitable to perform the actions described herein. A frame system such as the one depicted in FIG. 2A may further facilitate positioning and a wider range of motion, such as for the robotic manipulator to serve multiple vehicles across different parking bays. A frame system may facilitate repositioning of the system such as based on different vehicle sizes, parking alignments, or environmental constraints. In this example, the rail facilitates movement of the robotic system across multiple bays; however, the skilled in the art will understand that the robotic manipulator may be disposed to serve a single parking bay.

In further reference to FIG. 2B, the coupling assembly 120 is attached via an attachment interface 160 to a distal end of the robotic manipulator (not shown). The coupling assembly 120 is a mechanical interface configured to facilitate a controlled coupling and uncoupling of the charging connector 400 with the connector in a releasable manner.

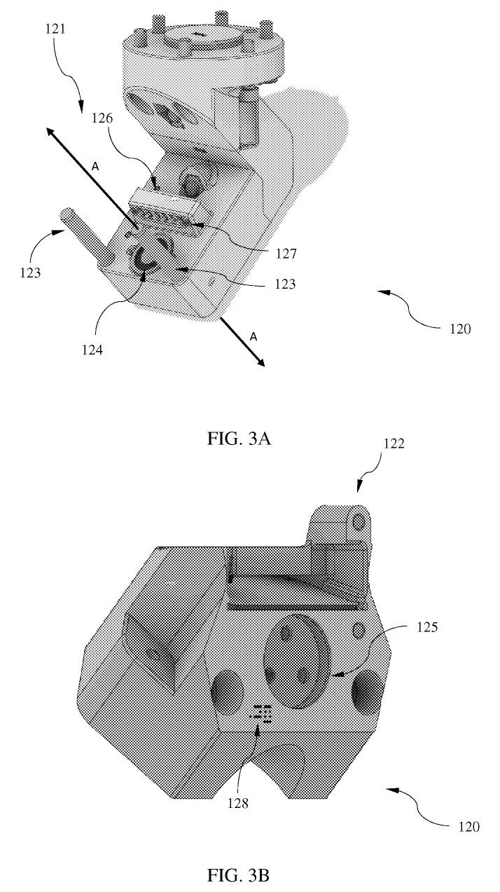

In further reference to FIGS. 3A and 3B, a coupling assembly 120 is depicted. In this exemplary embodiment, the coupling assembly comprises two members: a first member 121, in more detail depicted in FIG. 3A, configured to be attached to the distal end of the robotic manipulator (not shown) and a counter-member 122 in more detail depicted in FIG. 3B, attached to the charging connector (not shown) and comprising the necessary features for counter coupling. The counter-member 122 is coupled to the charging connector, and is referred to herein as the connector assembly 400, and constitutes the structure facilitates interaction with the coupling assembly 120, such that the robotic manipulator 110 manipulates, and position the connector assembly for mating to and unmating from the EV inlet.

In some cases, the coupling features of the counter member 122 may already be integrated within the charging connector and in such a case an add-on counter member may not be required. In such case, the coupling assembly is configured to directly engage with the charging connector.

In reference to FIG. 3A, the exemplary coupling assembly 120 comprises two aligning members 123, which are disposed to at least partially align the first member 121 with the counter-member 122 during coupling. The aligning members 123 are structured to substantially restrict the movement of the connector assembly relative to the coupling assembly to preferably a single degree of freedom. The aligning members 123 are configured to permit movement along the aligning direction while constraining movement in other directions. The degree of freedom along which the charging connector assembly is permitted to move relative to the coupling assembly, as described herein, is referred to as the aligning direction, and depicted as A in FIG. 3A.

As depicted in FIG. 3A, the aligning members are protruding structures configured to engage with corresponding recessed counter features on the connector assembly. However, such protruding structures may have various shapes, including but not limited to: cylindrical pins, tapered or conical guides, flat or rectangular projections, which may provide a restriction of the movement along a single degree of freedom. The specific shape and configuration of the aligning members may be selected based on mechanical constraints, alignment precision requirements, and environmental considerations.

In reference to FIG. 3B., the counter-member 122 comprises markers 128 configured to facilitate position detection. Markers 128 facilitate the detection device 150 to determine the position of the connector assembly 400, either when it is plugged into the EV inlet and/or when it is releasably supported by the docking assembly. Such markers may be disposed either directly on the charging connector or on the connector assembly, as shown in FIG. 3B, depending on the design and detection requirements. Markers may include fiducial markers or may be standard structural features of the connector assembly, such as edges, contours, or other inherent components that can serve as reference points for position detection. Other markers may be optical, magnetic, or electronic identifiers, including but not limited to retroreflective surfaces, infrared patterns, RFID tags, barcodes, or visual markers with machine-readable patterns

In reference to FIG. 3A, the coupling assembly 120 comprises an electromagnetic portion 124 configured to engage with a corresponding electromagnetic portion 125 of the connector assembly, and hold them together when brough together for coupling. The electromagnetic portions 124 and 125 may be configured as electromagnets, permanent magnets, or hybrid magnetic systems. The engagement force may be adjustable based on operational conditions.

In reference to FIG. 3A, the coupling assembly 120 comprises a sensor 126 for providing information about a relative position between the coupling assembly and the connector assembly. The sensor 126 may be configured to detect alignment, proximity, and orientation of the connector assembly relative to the coupling assembly. The sensor may be selected from optical sensors, proximity sensors, Hall effect sensors, inductive sensors, LiDAR, or camera-based vision systems, depending on the detection requirements.

In reference to FIG. 3A, the coupling assembly 120 comprises one or more electrical contacts 127 for establishing an electrical connection between the connector assembly and the coupling assembly. The electrical contacts 127 may be designed for power transmission, data communication, or both. Suitable contacts may include spring-loaded pins, conductive pads, magnetic connectors, or inductive coupling elements, depending on the application requirements. The electrical contacts 127 may incorporate wear-resistant coatings, self-cleaning mechanisms, or flexible mounting structures to enhance reliability during repeated coupling and decoupling cycles.

The control unit 130 is configured to transmit a mechanical or electrical signal to an actuated latch mechanism 129 disposed at the connector assembly which is depicted in FIG. 2B. The latch mechanism 129 is operable to switch between: a latched position, which prevents the removal of the charging connector from the EV inlet, facilitating a connection during charging; and an unlatched position, which allows the charging connector to be removed from the EV inlet, facilitating uncoupling when charging is complete or when manual or automated intervention is required. The actuated latch mechanism may be implemented as a solenoid-driven lock, a motorized latch, a mechanical locking pin, or a magnetic retention system, depending on the design requirements. The latch mechanism may include a feedback sensor to provide real-time status information to the control unit 130.

The coupling assembly may comprise a contamination discarding feature, such as a recess (not shown) positioned to facilitate the expulsion of contaminants by gravity. The recess can be disposed in a downward-facing orientation, preventing the accumulation of dust, debris, or other contaminants that could interfere with the coupling between the coupling assembly and connector assembly. In some embodiments, the contamination discarding feature may include: drainage channels, which direct contaminants away from the coupling interface, angled recess walls, self-cleaning surfaces, or a secondary outlet, positioned to allow accumulated contaminants to exit through an alternate path.

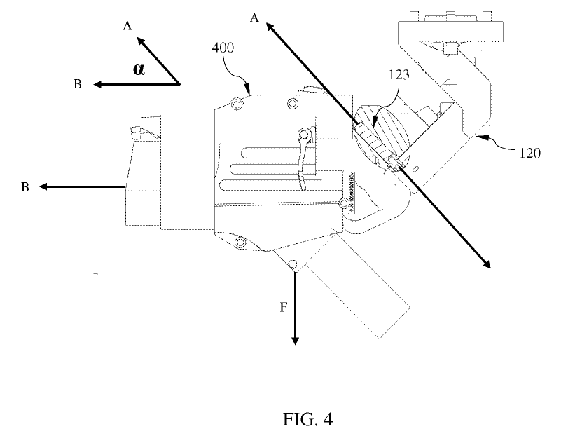

In reference to FIG. 4, the connection direction B is depicted, which is a direction comprising the movement path along which the connector assembly 400 travels when being coupled to or uncoupled from the EV inlet 310. In further reference to FIG. 4, a cut-out of the coupling assembly 120 is provided, which shows an aligning member 123. The aligning member 123 is positioned within the coupling assembly 120 such that, when the coupling assembly 120 is coupled to the connector assembly 400 as shown, the aligning direction A and the insertion direction B form an angle α, the angle being within a range of 10 to 170 degrees, preferably within a range of 15 to 90 degrees, and more preferably within a range of 30 to 60 degrees.

The connection direction B may further, or alternatively, be defined as a direction that forms an angle with respect to the direction of gravity, ranging between 30 and 95 degrees, and preferably between 75 and 90 degrees

The aligning direction A is disposed such that a gravitational force F resulting from the weight of the connector assembly 400 at least partially secures the coupling between the coupling assembly 120 and the connector assembly 400 when the charging connector is positioned in the connection direction B. Accordingly, the weight of the connector assembly 400 contributes to maintaining the alignment and stability of the connection, reducing the need for additional mechanical force to secure the coupling during the mating process.

In FIG. 3A, the aligning member comprises two protruding members for engaging with two counter recessed members of the connector assembly. In some cases, the recessed members include a contamination discarding feature, the feature including a recess disposed such that contaminants entering the recessed member are expelled by gravity. The aligning member comprises a contamination discarding feature, the feature including a recess aligned with the protruding member and covered by a flap, wherein, during coupling, the protruding member displaces contaminants past the flap.

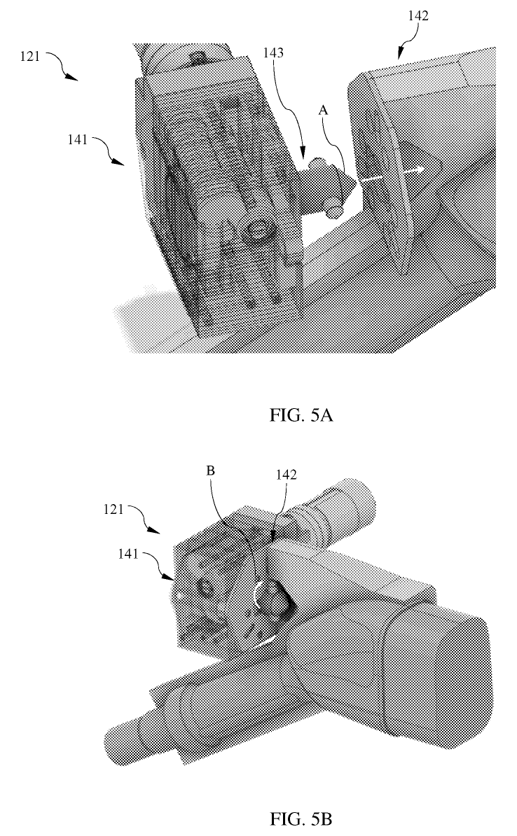

FIGS. 5A and 5B depict an alternative embodiment of a coupling assembly 121, which includes first member 141. In this embodiment, the coupling assembly has a first aligning member A with protruding engagement features, moveable with respect to the coupling assembly, preferably moveable along and about the alignment direction, and more preferably moveable with a substantially screw-like motion, for example, a pivotable conical member with lock pins (see 143). The first aligning member A substantially limits motions of the connector assembly to 1 or 2 degrees of freedom. The coupling assembly includes second aligning member(s) to further limit the relative movement between coupling assembly and connector assembly, substantially restricting to 1 degree of freedom, and facilitating a repeatable coupling position, for example, one or more ball-and-socket interfaces B as depicted in FIG. 5B. The first aligning member A is inserted into the counter assembly 142, providing initial alignment and engagement between the coupling assembly 121 and connector assembly, which brings them to the partially coupled state. Preferably, in the partially coupled state the second aligning member(s) are in contact with their counter member(s).

In the partially coupled state, the first aligning member A is rotated, preferably rotated with respect to the coupling assembly, to facilitate engagement between the protruding engagement features and the connector assembly. Subsequently, or in parallel, the first aligning member A is moved with respect to the coupling assembly, preferably moved towards the coupling assembly, effectively pulling the coupling and connector assembly together to secure the coupling, and preferably further engaging the second alignment member(s) with their counter members.

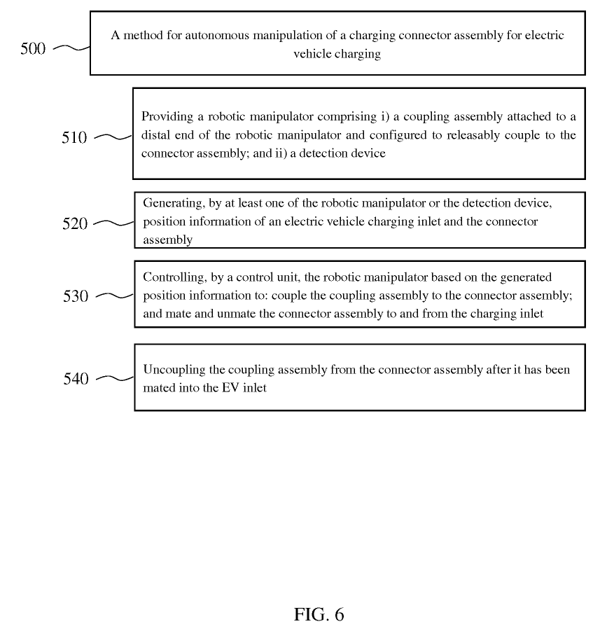

Referring now to FIG. 6, a flowchart is shown of an example method 500 for controlling a system in accordance with the first embodiment of the invention.

FIG. 6 depicts a method 500 for manipulating a charging connector assembly for the autonomous charging of an electric vehicle. Step 510 comprises providing a robotic manipulator including i) a coupling assembly attached to a distal end of the robotic manipulator and configured to releasably couple to the connector assembly, and ii) a detection device configured to generate position information. Step 520 comprises generating, by at least one of the robotic manipulator or the detection device, position information of an electric vehicle charging inlet and the connector assembly. Step 530 comprises controlling, by a control unit, the robotic manipulator based on the generated position information to couple the coupling assembly to the connector assembly and to mate and unmate the connector assembly to and from the charging inlet.

As described herein, the coupling process is performed to retrieve the connector assembly either from the docking unit or from the EV inlet when the connector assembly is mated to the vehicle. The uncoupling process is performed after the connector assembly has been positioned, either by being mated to the EV inlet or by being docked in the docking unit.

In more detail, Step 530 comprises controlling, by the control unit, the robotic manipulator based on the generated position information to couple the coupling assembly to the connector assembly and to mate and unmate the connector assembly to and from the charging inlet.

To initiate coupling when the connector assembly is docked in the docking unit, the control unit controls the robotic manipulator to position the coupling assembly relative to the connector assembly based on the predetermined docking position. In some embodiments, additional position information generated by the image-generating device may be acquired to refine the position of the connector assembly while docked. Once the connector assembly has been coupled to the coupling assembly, additional locking steps may take place to secure the coupling. These steps may include the activation of a magnetic mechanism, where electromagnets in the coupling assembly engage with corresponding magnetic elements in the connector assembly to reinforce the coupling. Alternatively, or in addition, a pivotal locking mechanism may be employed, wherein a pivot pin or locking element rotates into position to mechanically secure the coupling, such as depicted in the exemplary embodiment of FIG. 5B. Subsequently, the control unit controls the robotic manipulator to undock the connector assembly from the docking unit and to manipulate the connector assembly for subsequent mating to the EV inlet in accordance with the generated and/or refined position information.

The subsequent mating is initiated by controlling the robotic manipulator to position the connector assembly relative to the EV inlet based on position information of the EV inlet. The control unit may use position information generated by the detection device to align the connector assembly substantially along a predefined connection direction.

As the connector assembly approaches the EV inlet, additional refined position information may be acquired by the image-generating device to verify alignment and correct any positional deviations. The control unit then controls the robotic manipulator to apply a controlled insertion force along the connection direction to mate the connector assembly to the EV inlet, while monitoring force and/or position feedback to confirm seating and mechanical and electrical engagement.

Once the connector assembly is mated into the charging inlet, a confirmation of proper mechanical and electrical engagement may be performed. Such confirmation may include detecting a signal from a latching mechanism of the EV inlet, monitoring force and/or position feedback indicative of full insertion, and/or receiving an electrical handshake signal indicating readiness for energy transfer.

At this stage, while the connector assembly remains mated to the charging inlet and the coupling assembly is coupled to the connector assembly, the control unit stores position information of the connector assembly generated, for example, by internal sensing systems of the robotic manipulator. Such position information may be derived from joint position data, kinematic calculations, and/or internal encoder signals of the robotic manipulator, thereby defining a precise spatial position and orientation of the connector assembly in its mated state.

The stored position information may define a reference position indicative of an expected mated position of the connector assembly and may subsequently be used by the control unit to control re-coupling of the coupling assembly to the connector assembly and initiation of a subsequent unmating operation.

Subsequently, the control unit initiates uncoupling of the coupling assembly from the connector assembly while the connector assembly remains mated to the charging inlet. Uncoupling may comprise releasing a magnetic retention system of the coupling assembly, for example by deactivating one or more electromagnets, thereby disengaging the mechanical connection between the robotic manipulator and the connector assembly.

Alternatively, or additionally, uncoupling may comprise actuating a mechanical locking mechanism, such as retracting a locking pin or pivot element, to release the coupling assembly from the connector assembly. Once uncoupled, the robotic manipulator may be moved away from the charging inlet, allowing the connector assembly to remain mated to the EV inlet and enabling the charging process to proceed independently of the robotic manipulator

At this stage, the image-generating device may acquire position information of the connector assembly while the connector assembly remains mated to the charging inlet and the robotic manipulator is uncoupled. The control unit may store said position information as additional stored position information corresponding to the mated state of the connector assembly. The additional stored position information may be used, optionally in combination with the position information generated by the internal sensing systems of the robotic manipulator, to define or refine a reference position for a subsequent unmating operation.

The steps of mating and unmating do not necessarily occur sequentially or immediately after one another. In many implementations, after establishing the mating connection and confirming engagement, the connector assembly is uncoupled from the robotic manipulator, thereby allowing the robotic manipulator to perform other tasks. The control unit may subsequently control re-coupling of the coupling assembly to the connector assembly and initiation of unmating once the charging cycle has been completed.

Once a charging cycle has been completed, or when an instruction is received to unmate the connector assembly from the EV inlet, a re-coupling process is initiated. The control unit obtains position information of the connector assembly to determine a strategy for coupling the robotic manipulator to the connector assembly and for subsequently unmating and retrieving the connector assembly from the EV inlet.

If stored position information of the connector assembly is available, such information may be used as a reference position indicative of an expected mated position. This enables the control unit to position the robotic manipulator in proximity to the connector assembly based on the reference position and, if required, to acquire additional position information using the image-generating device for refinement prior to re-coupling and unmating. Additionally, the EV may provide real-time status updates, including connector engagement status, location data, or historical connection points, allowing the control unit to determine the connector assembly’s position.

Once the position of the connector assembly has been determined, the control unit initiates a coupling process in a manner corresponding to that described in Step 530. After the connector assembly has been successfully re-coupled to the coupling assembly, the control unit controls the robotic manipulator to unmate the connector assembly from the EV inlet and to retrieve the connector assembly for subsequent manipulation, including docking if required.

Optionally, once unmated from the EV inlet, the control unit may execute a docking operation to position the connector assembly into the docking unit. This may comprise controlling the robotic manipulator to move the connector assembly toward the docking unit based on pre-stored docking position data and/or real-time position information generated by the detection device. Subsequently, the system docks the connector assembly into the docking unit using a strategy analogous to the mating strategy described in Step 530.

In a manner similar to that described in Step 540, the connector assembly is uncoupled from the robotic manipulator after docking. Prior to uncoupling, the control unit may determine or verify that the connector assembly has been successfully docked in the docking unit and retained via a latching or locking mechanism. Such verification may involve sensor feedback and/or positional confirmation using the detection device. Once docking is confirmed, the control unit initiates release of the connector assembly from the coupling assembly, for example by deactivating a retention mechanism. A controlled separation movement may then be executed to detach the robotic manipulator from the connector assembly.

Preferably, the control unit stores pre-determined position data corresponding to the docking unit, as the docking unit is typically a fixed structure arranged in a substantially known position, in contrast to the EV and EV inlet, which may vary due to vehicle type, parking accuracy, or external conditions. The docking unit may comprise a receptacle having structural features substantially similar to those of an EV inlet, thereby simulating mating alignment conditions. In such embodiments, position information of the receptacle may be generated by the detection device and/or derived from pre-stored docking position data maintained in the control unit.

### EXEMPLARY EMBODIMENTS

In an exemplary embodiment, the connector assembly may offer multiple coupling options, such as multiple counter-members that allow for alternative engagement configurations. In such a case, the coupling strategy involves determining which counter-member to engage and issuing the corresponding instructions to the robotic manipulator. For instance, if a connector assembly includes counter-members positioned on both the left and right sides, and the control unit receives vehicle-specific information indicating that the EV’s charge-port cover opens to the left or right of the EV inlet, the system may direct the manipulator to engage with the counter-member on the opposite side of the charge-port cover.

In an exemplary embodiment, the control unit determines, based on position information, whether the coupling assembly and the connector assembly have reached a partially coupled state. The partially coupled state is characterized by an initial engagement of the aligning members with the counter-member of the connector assembly but without full mechanical engagement. If the determination confirms that the partially coupled state has been reached, the control unit transitions the system into a fully coupled state. A differentiated force pattern may be applied. For example, the force applied during the initial coupling phase (uncoupled to partially coupled) may be lower to avoid unintended impact, while the force applied when transitioning from the partially coupled state to the fully coupled state is adapted to ensure full engagement.

In an exemplary embodiment, the system utilizes sensor feedback from the coupling assembly to determine that the fully coupled state has been reached. The coupling assembly comprises at least one sensor configured to provide real-time information about the relative position between the connector assembly and the coupling assembly. Based on this sensor data, the system can determine whether full engagement has been achieved.

In an exemplary embodiment, the coupling assembly includes a retention mechanism, which is configured to releasably engage with a counterpart on the connector assembly. This retention mechanism may include at least one of an electromagnetic coupling system, a mechanical latch, or a combination of both. Upon reaching the fully coupled state, the retention mechanism is engaged to secure the connection, so that that the connector assembly remains coupled to the robotic manipulator until further instructions are given for uncoupling.

Additionally, determining that the fully coupled state has been reached may comprise receiving a signal from the retention mechanism, indicating that the electromagnetic or mechanical engagement has been activated. Such a signal may confirm that the electromagnet is successfully engaged with the counterpart of the connector assembly.

In an exemplary embodiment of an uncoupling strategy, after the connector assembly has been inserted into either the EV inlet or the docking unit, the control unit delays releasing the coupling mechanism (e.g., disengaging the electromagnet) until it receives a confirmation signal verifying successful insertion. Such a signal may indicate the engagement of a locking pin from the EV inlet or support assembly, preventing movement of the connector assembly, or the activation of a locking pin that restricts operation of the connector’s latching mechanism. Additionally, confirmation may be received through detection of the connector assembly’s engaged latching mechanism or verification of active energy transfer between the EV and the charging infrastructure, indicating a fully established electrical connection.

In an exemplary embodiment, during mating of the connector assembly to the charging inlet, the control unit stores position information of the connector assembly generated by internal sensing systems of the robotic manipulator while (i) the coupling assembly is coupled to the connector assembly and (ii) the connector assembly is mated to the charging inlet. After successful mating and confirmation of mechanical and/or electrical engagement, the control unit controls uncoupling of the coupling assembly from the connector assembly, allowing the connector assembly to remain mated to the charging inlet during the charging cycle. Prior to a subsequent unmating, the stored position information is retrieved and used by the control unit as a reference position indicative of an expected mated position of the connector assembly. Based on this reference position, the control unit controls re-coupling of the coupling assembly to the connector assembly by positioning the robotic manipulator in proximity to the expected mated position and, if required, refining the position using additional position information generated by the detection device. Once re-coupled, the control unit controls unmating of the connector assembly from the charging inlet and subsequent retrieval of the connector assembly for further manipulation, including docking if required.

In an exemplary embodiment, the stored position information defines a reference position indicative of an expected position of the connector assembly, in particular an expected mated position relative to the charging inlet. The reference position may represent a spatial pose comprising translational coordinates and rotational orientation of the connector assembly as determined during a previous mating operation. Prior to a subsequent unmating, the control unit positions the robotic manipulator based on the reference position so as to approach the connector assembly at the expected position. The control unit further receives additional position information of the connector assembly generated by the image-generating device which is used to verify and refine the reference position before re-coupling of the coupling assembly to the connector assembly. The control unit determines a deviation between the reference position and the position information generated by the image-generating device. The deviation may be calculated as a spatial distance and/or angular offset between the expected position and the detected position of the connector assembly. If the deviation exceeds a predefined threshold, the control unit causes the image-generating device to acquire further position information for additional refinement prior to executing the coupling and unmating operations. The predefined threshold is about 50 mm, preferably about 20 mm, and more preferably about 10 mm. The use of a graduated threshold allows the system to balance efficiency and positioning accuracy, wherein larger deviations may trigger additional image acquisition cycles and smaller deviations may allow immediate execution of the coupling and unmating sequence.

In an exemplary embodiment corresponding to the method of any of the preceding claims, the system comprises a first robotic manipulator and a second robotic manipulator operatively connected to the control unit. The control unit assigns the mating of the connector assembly to the charging inlet to the first robotic manipulator and assigns a subsequent unmating of the connector assembly from the charging inlet to the second robotic manipulator. During execution of the mating operation by the first robotic manipulator, while the coupling assembly is coupled to the connector assembly and the connector assembly is mated to the charging inlet, the control unit stores position information of the connector assembly generated by internal sensing systems of the first robotic manipulator. Such position information may comprise joint position data, kinematic pose calculations, and/or encoder-derived spatial coordinates defining the mated position of the connector assembly relative to the charging inlet. The stored position information is transmitted, by the control unit, to the second robotic manipulator prior to execution of the unmating operation. The stored position information defines a reference position indicative of an expected position of the connector assembly in its mated state. Prior to unmating, the control unit controls the second robotic manipulator based on the transmitted reference position to perform coupling of its coupling assembly to the connector assembly. The second robotic manipulator is positioned in accordance with the stored position information and, if required, may further obtain additional position information via its detection device to refine alignment. After successful coupling, the control unit controls the second robotic manipulator to unmate the connector assembly from the charging inlet, thereby enabling task distribution between multiple robotic manipulators and allowing parallel or sequential task execution within the charging infrastructure.

FIG. 7 depicts a generalized example of a suitable computing environment 135, 600 in which the described innovations may be implemented, without implying any limitation as to scope or functionality, as the innovations may be realized in general-purpose or special-purpose systems such as a desktop computer, laptop, server, tablet, or other computing device. The computing environment 600 includes one or more processing units, such as a central processing unit (CPU) 611 and a graphics processing unit (GPU) 612, configured to execute computer-executable instructions, and memory components 613, 614 comprising volatile and/or non-volatile memory storing software instructions implementing the functions described herein. Optional components may include storage 650, one or more input devices 630, one or more output devices 640, and one or more communication connections 620, coupled via an interconnection mechanism such as a bus or communication fabric, with operating system software coordinating execution of application software. The input device(s) 630 may include a keyboard, mouse, touchscreen, voice recognition system, or other interface for providing input such as annotations, parameter adjustments, or manual overrides, and the output device(s) 640 may include a display, speaker, or other interface for presenting reports, task status updates, or sensor data visualizations.

As used in the present disclosure, the term "position" refers to a spatial position and/or orientation in any one of a three, four-, five-, or six-dimensional space of an object.

Terms like “configured to” or “able to” encompass components in active, inactive, or standby states, unless otherwise specified.

The terms “comprising,” “including,” and “having” are used inclusively and do not exclude additional elements. “Or” is inclusive, meaning one, some, or all items in a list. The articles “a,” “an,” and “the” mean “one or more” unless specified otherwise. “At least one of” or “and/or” refers to any combination of listed items.

The term “allow” includes permitting, instructing, enabling, or facilitating a specified action.

1. A method for autonomous manipulation of a charging connector assembly for the charging of an electric vehicle, comprising:
providing a robotic manipulator comprising i) a coupling assembly attached to a distal end of the robotic manipulator and configured to releasably couple to the connector assembly; and ii) a detection device;
generating, by at least one of the robotic manipulator or the detection device, position information of a charging inlet of the vehicle and the connector assembly; and
controlling, by a control unit, the robotic manipulator based on the generated position information for: coupling the coupling assembly to the connector assembly and mating the connector assembly into the charging inlet.

2. The method according to claim 1, wherein the detection device comprises an image-generating device coupled to the robotic manipulator.

3. The method according to claim 1, further comprising:
during mating of the connector assembly to the charging inlet, storing, by the control unit, position information of the connector assembly generated by the robotic manipulator while i) the coupling assembly is coupled to the connector assembly; and ii) the connector assembly is mated to the charging inlet;
uncoupling the coupling assembly from the connector assembly;
prior to a subsequent unmating, using the stored position information to control coupling of the coupling assembly to the connector assembly; and
unmating the connector assembly from the charging inlet.

4. The method according to claim 1, further comprising:
storing, by the control unit, position information of the connector assembly generated by the detection device after the connector assembly has been mated to the charging inlet and decoupled from the coupling assembly;
prior to a subsequent unmating, using the stored position information to control a subsequent coupling of the coupling assembly to the connector assembly; and
unmating the connector assembly from the charging inlet.

5. The method according to claim 3, wherein the stored position information defines a reference position indicative of an expected position of the connector assembly.

6. The method according to claim 5, wherein prior to the subsequent unmating, the control unit further receives additional position information of the connector assembly generated by the image-generating device.

7. The method according to claim 6, wherein the control unit is configured to determine a deviation between the reference position and the position information generated by the image-generating device, and, if the deviation exceeds a predefined threshold, to cause the image-generating device to acquire further position information for additional refinement.

8. The method according to claim 7, wherein the predefined threshold is about 50 mm, preferably about 20 mm, and more preferably about 10 mm.

9. The method according to claim 1, further comprising:
docking the connector assembly into a docking unit having a predetermined position, wherein the docking is controlled by the control unit based on the docking unit predetermined position.

10. The method according to claim 9, further comprising:
prior to docking, and based on the predetermined docking unit position, positioning the robotic manipulator while coupled to the connector assembly such that the image-generating device is able to generate refined position information of the docking unit;
docking the connector assembly into the docking unit based on the refined position information; and
uncoupling the coupling assembly from the connector assembly.

11. The method according to claim 10, wherein the refined position information of the docking unit is acquired when a distance between the connector assembly and docking unit falls below a predefined proximity threshold.

12. The method according to claim 1, further comprising:
providing a first robotic manipulator and a second robotic manipulator;
assigning, by the control unit, mating of the connector assembly to the charging inlet to the first robotic manipulator and unmating of the connector assembly from the charging inlet to the second robotic manipulator;
storing position information of the connector assembly generated by the robotic manipulator while i) the coupling assembly is coupled to the connector assembly; and ii) the connector assembly is mated to the charging inlet;
prior to a subsequent unmating, controlling the second robotic manipulator based on the stored position information generated by the first robotic manipulator to control coupling of the coupling assembly to the connector assembly; and
controlling the second robotic manipulator for unmating the connector assembly from the charging inlet.

13. The method according to claim 1, further comprising determining, by the control unit, a weighted combination of position information generated by the robotic manipulator and position information generated by the detection device, wherein the weighting applied to each position information is defined as a function of an accuracy metric associated with the respective position information.

14. The method according to claim 13, wherein the accuracy metric comprises a confidence value associated with each position information, the confidence value representing a reliability level of the respective position information, and wherein the control unit adjusts the weighting proportionally to the confidence value.

15. The method according to claim 4, wherein the stored position information defines a reference position indicative of an expected position of the connector assembly.

16. The method according to claim 15, wherein prior to the subsequent unmating, the control unit further receives additional position information of the connector assembly generated by the image-generating device.
